(19) United States
(12) Patent Application Publication
(10) Pub. No.: US 2023/0112864 A1
(43) Pub. Date: Apr. 13, 2023

(54) LOCKING MECHANISM FOR DETACHABLE FRAME

(71) Applicant: Hui Zhao, Los Angeles, CA (US)

(72) Inventor: Hui Zhao, Los Angeles, CA (US)

(21) Appl. No.: 17/708,920

(22) Filed: Mar. 30, 2022

Related U.S. Application Data
(60) Provisional application No. 63/253,708, filed on Oct. 8, 2021.

(51) Int. Cl. F16B 5/00; F16B 12/44

(52) U.S. Cl. CPC F16B 5/0032; F16B 12/44; A47G 1/10

(57) ABSTRACT

A locking mechanism for detachable frames includes at least one detachable frame having at least one retaining through-hole; an edge connector having a left protrusion and a right protrusion, the left and right protrusions engaged with the retaining through-holes; and a locking retainer having a left retaining wall and a right retaining wall, the left and right retaining walls slidably coupled with the left protrusion and the right protrusion.

### FIELD OF THE DISCLOSURE

The present disclosure relates to a locking mechanism, and more particularly to a locking mechanism for detachable frames which could enable the detachable frames to be securely connected with each other simply and easily.

### BACKGROUND OF THE DISCLOSURE

Currently, the conventional frames, including picture frames and portrait frames, are usually one-piece structures, such as rectangular or square shapes. These traditional frames are bulky and could not be detached into several pieces, and in such a manner, those frames may occupy too many spaces while those frames are not in use. In addition, while those frames are stored and transported from one place to another, those frames are easy to be damaged and the main body of those frames may be deformed by the shaking and pressing during the long-term transportation.

In order to solve the above problems, there may exist a desire to provide frames, including, but not limited to picture frames and portrait frames, which can be detached into several pieces while those frames are not in use, and could be securely coupled with each other for specific purposes of needs.

All referenced patents, applications, and literature are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the locking mechanism for detachable frames comprises at least one detachable frame having at least one retaining through-hole; an edge connector having a left protrusion and a right protrusion, the left and right protrusions engaged with the retaining through-holes; and a locking retainer having a left retaining wall and a right retaining wall, the left and right retaining walls slidably coupled with the left protrusion and the right protrusion.

In another aspect combinable with the general implementation, the retaining through-hole comprises a right retaining through-hole engaged with the right protrusion and a left retaining through-hole engaged with the left protrusion.

In another aspect combinable with the general implementation, the left protrusion is parallel to the right protrusion.

In another aspect combinable with the general implementation, the left retaining wall is parallel to the right retaining wall.

In another aspect combinable with the general implementation, the left protrusion comprises a left groove slidably engaged with the left retaining wall, and the right protrusion comprises a right groove slidably engaged with the right retaining wall.

In another aspect combinable with the general implementation, the edge connector further comprises a supporting plate where the left protrusion and the right protrusion are vertically supported thereon.

In another aspect combinable with the general implementation, the left protrusion is arranged at a distance “L” with respect to the right protrusion, and a left retaining edge of the left retaining wall is arranged at a distance “1” with respect to a right retaining edge of the right retaining wall, wherein the distance “L” is greater than the distance “1.”

In another aspect combinable with the general implementation, at least one detachable frame comprises a first detachable frame and a second detachable frame connected with the first detachable frame through the engagement of the edge connector and the locking retainer.

In another aspect combinable with the general implementation, the locking retainer further comprises a middle retaining wall extended between the left retaining wall and the right retaining wall, wherein the middle retaining wall, the left retaining wall, and the right retaining wall are formed a U-shaped receiving cavity.

In another aspect combinable with the general implementation, the left protrusion and the right protrusion are passed through the retaining through holes.

In another aspect combinable with the general implementation, the left protrusion comprises a left groove formed on a left distal end of the left protrusion, and the right protrusion comprises a right groove formed on a left distal end of the right protrusion.

In another aspect combinable with the general implementation, the locking retainer further comprises a left retaining slot formed between the left retaining wall of the locking retainer and a main supporting base of the locking retainer and a right retaining slot formed between the right retaining wall of the locking retainer and the main supporting base of the locking retainer.

In another aspect combinable with the general implementation, the left protrusion further comprises a left tooth slidably engaged with the left retaining slot of the locking retainer.

In another aspect combinable with the general implementation, the right protrusion further comprises a right tooth slidable engaged with the right retaining slot of the locking retainer.

In another aspect combinable with the general implementation, the left protrusion comprises a left groove formed at a first distance from a left distal end of the left protrusion, wherein the first distance is smaller than a width of the left retaining slot.

In another aspect combinable with the general implementation, the left retaining slot has a width defining between the left retaining wall of the locking retainer and a main supporting base of the locking retainer.

In another aspect combinable with the general implementation, the right protrusion comprises a right groove formed at a second distance from a right distal end of the right protrusion, wherein the second distance is smaller than a width of the right retaining slot.

In another aspect combinable with the general implementation, the right retaining slot has a width defining between the right retaining wall of the locking retainer and a main supporting base of the locking retainer.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a locking mechanism for detachable frames according to an aspect of the embodiment.

FIG. 2 is a perspective view of an edge connector cooperated with the detachable frames according to an aspect of the embodiment.

FIG. 3 is a perspective view of a locking retainer according to an aspect of the embodiment.

FIG. 4 is a perspective view of the edge connector cooperated with the locking retainer to connect the detachable frames according to an aspect of the embodiment.

FIG. 5 is a perspective view of the edge connector cooperated with the locking retainer according to an aspect of the embodiment.

FIG. 6 is a side view of a locking mechanism for detachable frames according to an aspect of the embodiment.

FIG. 7 is a top and left view of the edge connector that cooperated with the locking retainer according to an aspect of the embodiment.

FIG. 8 is a top and right view of the edge connector that cooperated with the locking retainer according to an aspect of the embodiment.

FIG. 9 is a perspective view of the edge connector cooperated with the locking retainer according to an aspect of the embodiments.

FIG. 10 is a perspective view of the edge connector according to an aspect of the embodiment.

FIG. 11 is a perspective view of the edge connector and the locking retainer according to an aspect of the embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

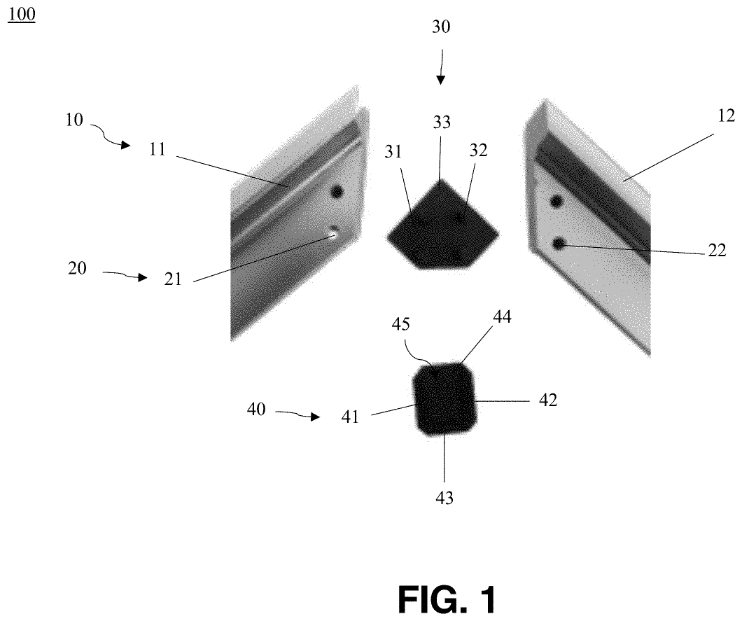

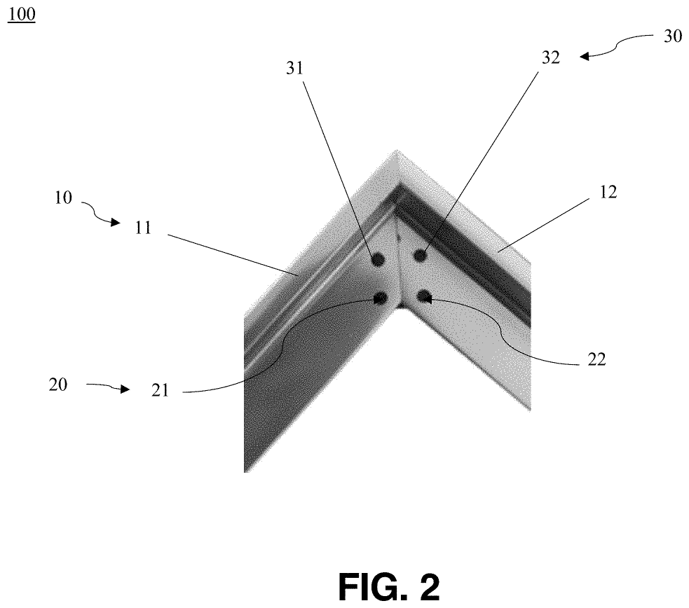

FIGS. 1-2 generally depict a locking mechanism for detachable frames according to an aspect of the embodiments.

Referring to FIG. 1, the locking mechanism 100 may comprise a plurality of detachable frames 10.

In some embodiments, the locking mechanism 100 for detachable frame 10 comprises at least one detachable frame 10, wherein the detachable frame 10 may comprise at least one retaining through-hole 20. For one example, the at least one detachable frame 10 may comprise a first detachable frame 11 and a second detachable frame 12.

In some embodiments, the first detachable frame 11 comprises at least one left retaining through-hole 21 and the second detachable frame 12 comprises at least one right retaining through-hole 22. The locking mechanism 100 may further comprise an edge connector 30 having at least one left protrusion 31 and at least one right protrusion 32, and a locking retainer 40 having a left retaining wall 41 and a right retaining wall 42. In such a manner, the left protrusion 31 and the right protrusion 32 may be engaged with the retaining through-holes 20.

Continuing to FIG. 2, in some embodiments, the first detachable frame 11 may comprise a pair of left retaining through-holes 21 and the second detachable frame 12 may comprise a pair of right retaining through-holes 22, wherein the left protrusion 31 formed on the edge connector 30 may be engaged with the left retaining through-hole 21 and the right protrusion 32 formed on the edge connector 30 may be engaged with the right retaining through-hole 22. For one example, the left protrusion 31 may be passed through the left retaining through-hole 21. For another example, the right protrusion 32 may be passed through the right retaining through-hole 22.

Referring to further details of FIG. 1, in some embodiments, the locking retainer 40 may further comprise a main supporting base 44 where the left retaining wall 41 and the right retaining wall 42 are integrally extended therefrom. For one example, the left retaining wall 41 may be parallel to the right retaining wall 42.

In some embodiments, the locking retainer 40 may further comprise a middle retaining wall 43 extended between the left retaining wall 41 and the right retaining wall 42, wherein the middle retaining wall 43, the left retaining wall 41, and the right retaining wall 42 may be integrally extended to form a U-shaped receiving cavity 45.

As shown in further details in FIG. 2, the first detachable frame 11 may be in contact with the second detachable frame 12, and the left protrusion 31 of the edge connector 30 may be passed through the left retaining through-hole 21 formed on the first detachable frame 11.

In another embodiment, the first detachable frame 11 may be in contact with the second detachable frame 12, and the right protrusion 32 of the edge connector 30 may be passed through the right retaining through-hole 22 formed on the second detachable frame 12. It should be noted that the first detachable frame 11 and the second detachable frame 12 may be connected with one another through the edge connector 30.

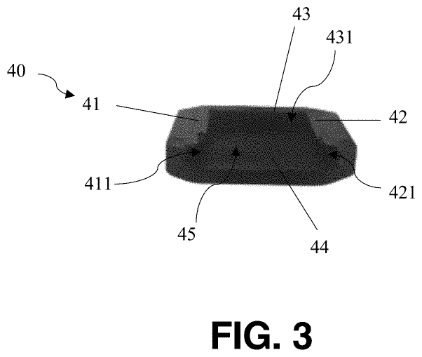

FIG. 3 generally depicts the locking retainer 40 of the locking mechanism according to an aspect of the embodiments.

Referring to FIG. 3, in some embodiments, the left retaining wall 41 may be integrally extended from the main supporting base 44 to form a left retaining slot 411, and the right retaining wall 42 may be integrally extended from the main supporting base 44 to form a right retaining slot 421. The middle retaining wall 43 may be integrally extended from the main supporting base 44 to form a middle retaining slot 431.

In some embodiments, the right retaining slot 421, the left retaining slot 411, and the middle retaining slot 431 may communicate with each other, wherein the right retaining slot 421, the middle retaining slot 431, and the left retaining slot 411 may surround the U-shaped receiving cavity 45.

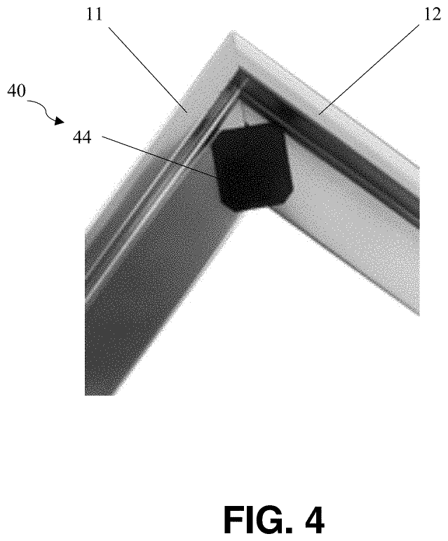

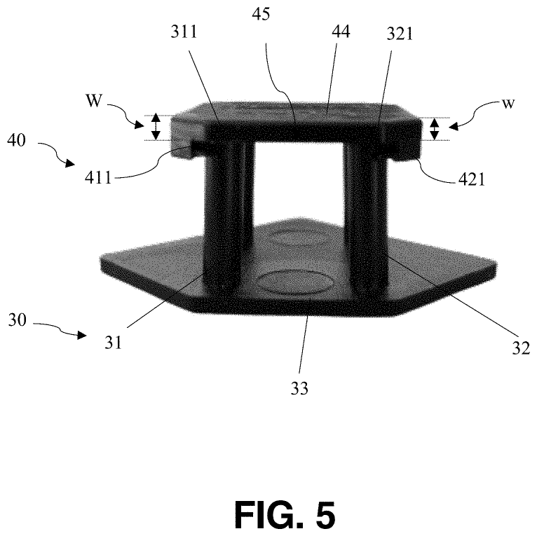

FIGS. 4-5 generally depict the locking retainer 40 cooperated with the edge connector to support the first detachable frame 11 being secured with the second detachable frame 12 according to an aspect of the embodiments.

Referring to FIG. 4, the locking retainer 40 may be parallelly moved with respect to the first detachable frame 11 and the second detachable frame 12 to cooperate with the edge connector.

Continuing to FIG. 5, the left protrusion 31 may comprise a left distal end 311 slidably engaged with the left retaining slot 411 of the locking retainer 40, and the right protrusion 32 may comprise a right distal end 321 slidably engaged with the right retaining slot 421. In one embodiment, the left distal end 311 of the left protrusion 31 and the right distal end 321 of the right protrusion 32 may be received inside the U-shaped receiving cavity 45.

In some embodiments, the edge connector 30 may further comprise a supporting plate 33 where the left protrusion 31 and the right protrusion 32 are supported thereon, wherein the left protrusion 31 may be vertically arranged on the supporting plate 33 and the right protrusion 32 may be vertically arranged on the supporting plate 33. For one example, while the left protrusion 31 and the right protrusion 32 are coupled with the locking retainer 40, the supporting plate 33 of the edge connector 30 may be parallel to the main supporting base 44 of the locking retainer 40.

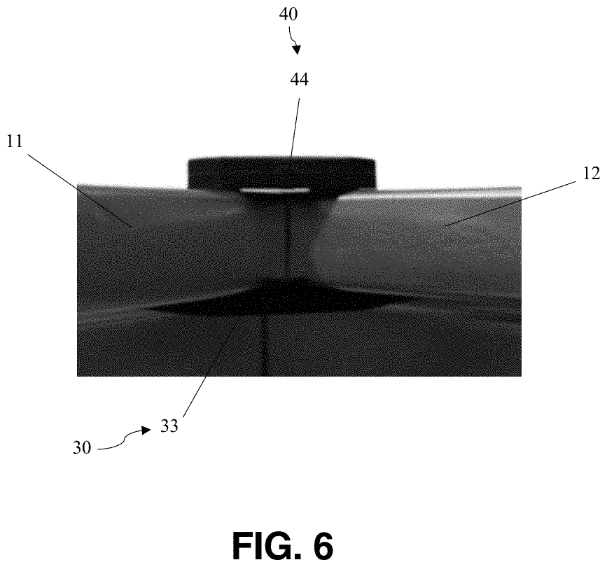

FIG. 6 generally depicts the locking retainer 40 cooperated with the edge connector 30 to support the first detachable frame 11 being secured with the second detachable frame 12 according to an aspect of the embodiments.

Referring to FIGS. 2 and 5-6, in some embodiments, while the left protrusions 31 are passed through the left retaining through-holes 21 formed on the first detachable frame 11 and the right protrusions 32 are passed through the right retaining through-holes 22 formed on the second detachable frame 12, the supporting plate 33 may be arranged on one side of the detachable frame, and the main supporting base 44 may arrange on an opposite side of the detachable frame. In other words, the detachable frames, including the first detachable frame 11 and the second detachable frame 12, maybe sandwiched between the supporting plate 33 of the edge connector 30 and the main supporting base 44 of the locking retainer 40. In other words, the supporting plate 33 of the edge connector 30 may be biased against the first detachable frame 11 and the second detachable frame 12. For another example, the main supporting base 44 of the locking retainer 40 may be biased against the first detachable frame 11 and the second detachable frame 12.

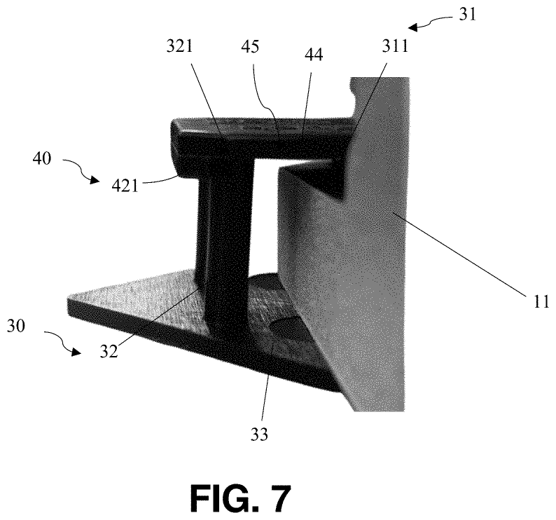

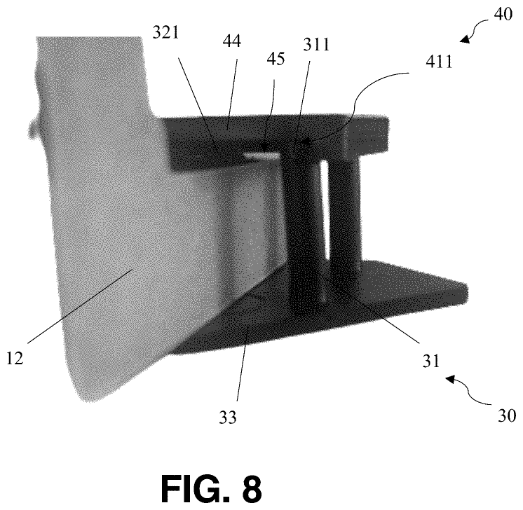

FIGS. 7-8 generally depict the locking retainer 40 cooperated with the edge connector 30 to support the first detachable frame 11 being secured with the second detachable frame 12 according to an aspect of the embodiments.

Referring to FIG. 7 and FIG. 8, while the left protrusion 31 engaged with the left retaining through-hole 21 of the first detachable frame 11 (as shown in FIG. 1) and the right protrusion 32 engaged with the right retaining through-hole 22 (as shown in FIG. 1) of the second detachable frame 12, the left distal end 311 of the left protrusion 31 and the right distal end 321 of the right protrusion 32 may be received inside the U-shaped receiving cavity 45 of the locking retainer 40.

In some embodiments, the left distal end 311 of the left protrusion 31 may be slidably engaged with the left retaining slot 411 of the locking retainer 40, and the right distal end 321 of the right protrusion 32 may be slidably engaged with the right retaining slot 421.

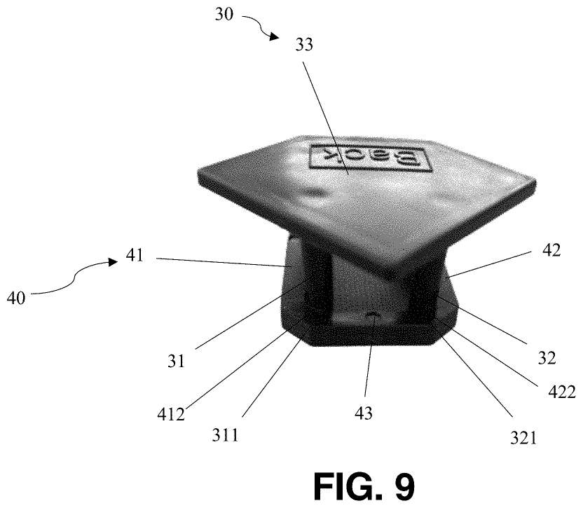

FIG. 9 generally depicts the edge connector 30 cooperated with the locking retainer 40 according to an aspect of the embodiments.

In some embodiments, the middle retaining wall 43 of the locking retainer 40 may be integrally extended from the left retaining wall 41 to form a left corner 412 and the middle retaining wall 43 of the locking retainer 40 may be integrally extended from the right retaining wall 42 to form a right corner 422.

In some embodiments, the left distal end 311 of the left protrusion 31 may be slidably engaged with the left retaining slot 411 (as shown in FIG. 5) of the locking retainer 40 and locked on the left corner 412 of the locking retainer 40, and at the same time, the right distal end 321 of the right protrusion 32 may be slidably engaged with the right retaining slot 421 (as shown in FIG. 5) and locked on the right corner 422 of the locking retainer 40. In such a manner, the right protrusion 32 may be affixed on the locking retainer 40, and at the same time, the left protrusion 31 may be affixed on the locking retainer 40.

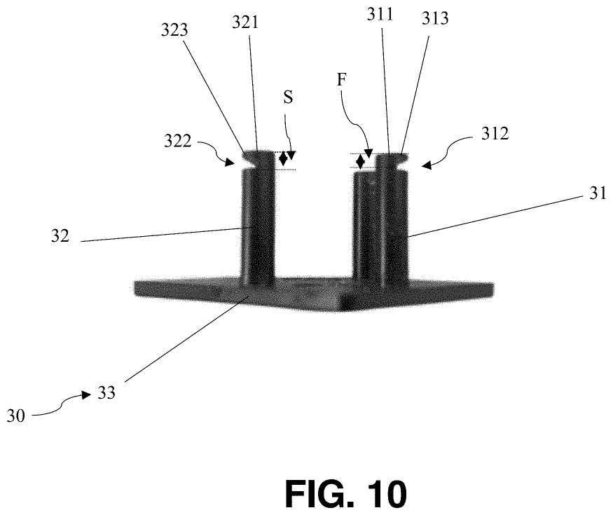

FIG. 10 generally depicts the edge connector 30 according to an aspect of the embodiments.

Referring to FIG. 10, the left protrusion 31 may further comprise a left tooth 313 formed on the left distal end 311 of the left protrusion 31, wherein the left tooth 313 may be slidably engaged with the left retaining slot 411 of the locking retainer 40, as shown in FIG. 5.

In some embodiments, the right protrusion 32 may further comprise a right tooth 323 formed on the right distal end 321 of the right protrusion 32, wherein the right tooth 323 may be slidably engaged with the right retaining slot 421 of the locking retainer 40, as shown in FIG. 5.

In some embodiments, the left protrusion 31 may further comprise a left groove 312 formed at a first distance “F” from the left distal end 311 of the left protrusion 31, wherein the first distance “F” may be smaller than a width “W” of the left retaining slot 411. Accordingly, the width “W” of the left retaining slot 411 may be defined between the left retaining wall 41 and the main supporting base 44 of the locking retainer 40, as shown in FIG. 5.

In some embodiments, the right protrusion 32 may further comprise a right groove 322 formed at a second distance “S” from the right distal end 321 of the right protrusion 32, wherein the second distance “S” may be smaller than a width “w” of the right retaining slot 421. Accordingly, the width “w” of the right retaining slot 421 may be defined between the right retaining wall 42 and the main supporting base 44 of the locking retainer 40. It should be noted that the first distance “F” defined by the left groove 312 of the left protrusion 31 may be equal to the second distance “S” defined by the right groove 322 of the right protrusion 32.

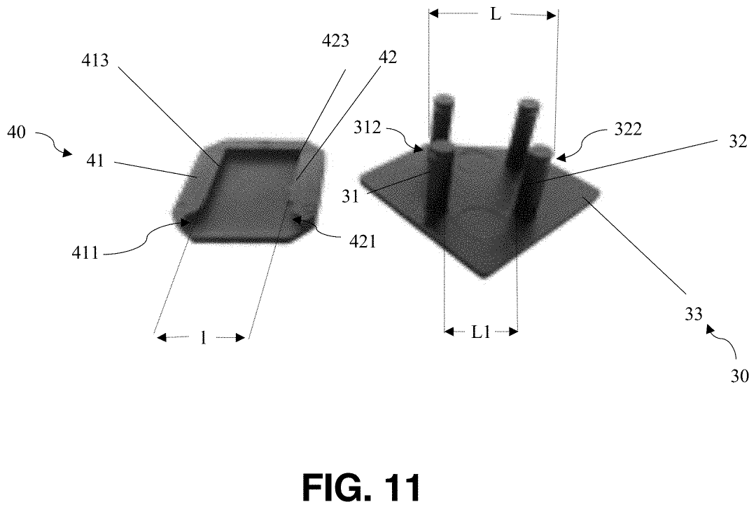

FIG. 11 generally depicts the locking retainer 40 and the edge connector 30 according to an aspect of the embodiments.

Referring to FIG. 11, in some embodiments, the left protrusion 31 may be parallel to the right protrusion 32. For one example, a length of the left protrusion 31 may be equal to a length of the right protrusion 32.

In some embodiments, the left protrusion 31 may be arranged at a distance “L” with respect to the right protrusion 32. According to the locking retainer 40, as shown in FIG. 11, the left retaining wall 41 may integrally extend towards the right retaining wall 42, wherein the left retaining wall 41 may define a left retaining edge 413, and the right retaining wall 42 may define a right retaining edge 423. For one example, the left retaining edge 413 of the left retaining wall 41 may be arranged at a distance “1” with respect to the right retaining edge 423 of the right retaining wall 42. It should be noted that the distance “L” defined between the right protrusion 32 and the left protrusion 31 may be greater than the distance “1” defined between the left retaining wall 41 and the right retaining wall 42, and in such a manner, the locking retainer 40 may be securely locked on the edge connector 30 with the left protrusion 31 being passed through the left retaining through-hole and the right protrusion 32 being passed through the right retaining through-hole.

In some embodiments, the distance “L” defined between the right protrusion 32 and the left protrusion 31 may be a maximum distance “L” which is defined between a left outer edge of the left protrusion 31 and a right outer edge of the right protrusion 32. The left outer edge may be defined by a periphery of the left protrusion 31. It should be noted that the left protrusion 31 may comprise the left outer edge and a left inner edge opposite of the left outer edge, wherein the left protrusion 31 may comprise a diameter defined between the left outer edge and the left inner edge. Accordingly, the right outer edge of the right protrusion 32 may be defined by a periphery of the right protrusion 32. It should be noted that the right protrusion 32 may comprise the right outer edge and a right inner edge opposite of the right outer edge, wherein the right protrusion 32 may comprise a diameter defined between the right outer edge and the right inner edge. Accordingly, the distance between the right inner edge of the right protrusion 32 and the left inner edge of the left protrusion 31 may be defined as a minimum distance “L1” between the right protrusion 32 and the left protrusion 31. In another embodiment, the maximum distance “L” may be greater than the minimum distance “L1”.

In some embodiments, the diameter of the left protrusion 31 may be equal to the diameter of the right protrusion 32. In another embodiment, the diameter of the left protrusion 31 may be smaller than or larger than the diameter of the right protrusion 32.

In some embodiments, the left groove 312 of the left protrusion 31 may be slidably engaged with the left retaining edge 413 of the left retaining wall 41, and the right groove 322 of the right protrusion 32 may be slidably engaged with the right retaining edge 423 of the right retaining wall 42, as shown further in FIG. 5.

According to all of the embodiments described above, a length of the left protrusion 31 and a length of the right protrusion 32 may be greater than a length of the left retaining through-hole and a length of the right retaining through-hole, and in such a situation, the left protrusion 31 and the right protrusion 32 may be passed through the left and right retaining through-holes. It should be noted that the left groove 312 of the left protrusion 31 and the right groove 322 of the right protrusion 32 may be exposed outside the left and right retaining through-holes to facilitate the left groove 312 and the right groove 322 being engaged with the locking retainer 40.

Similarly, while operations and/or methods may be depicted in the drawings in a particular order, this should not be understood as requiring that such operations be performed in the particular order shown or in sequential order, or that all illustrated operations and/or method steps be performed, to achieve desirable results. In certain circumstances, multitasking and parallel processing may be advantageous.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of locking mechanisms for detachable frames have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted, and also what essentially incorporates the essential idea of the embodiments. In addition, where the specification and claims refer to at least one of something selected from the group consisting of A, B, C and N, the text should be interpreted as requiring at least one element from the group which includes N, not A plus N, or B plus N, etc.

The words used in this specification to describe the various embodiments are to be understood not only in the sense of their commonly defined meanings but to include by special definition in this specification structure, material, or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims, therefore, include not only the combination of elements which are set forth but all equivalent structure, material, or acts for performing substantially the same function in substantially the same way to obtain substantially the same result. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A locking mechanism for detachable frames, comprising:
at least one detachable frame having at least one retaining through hole;
an edge connector having a left protrusion and a right protrusion, the left and right protrusions engaged with the retaining through-holes; and
a locking retainer having a left retaining wall and a right retaining wall, the left and right retaining walls slidably coupled with the left protrusion and the right protrusion.

2. The locking mechanism of claim 1, wherein the retaining through-holes comprises a right retaining through-hole engaged with the right protrusion and a left retaining through-hole engaged with the left protrusion.

3. The locking mechanism of claim 1, wherein the left protrusion is parallel to the right protrusion.

4. The locking mechanism of claim 1, wherein the left retaining wall is parallel to the right retaining wall.

5. The locking mechanism of claim 1, wherein the left protrusion comprises a left groove slidably engaged with the left retaining wall, and the right protrusion comprises a right groove slidably engaged with the right retaining wall.

6. The locking mechanism of claim 1, wherein the edge connector further comprises a supporting plate where the left protrusion and the right protrusion are vertically supported thereon.

7. The locking mechanism of claim 1, wherein the left protrusion is arranged at a distance “L” with respect to the right protrusion, and a left retaining edge of the left retaining wall is arranged at a distance “1” with respect to a right retaining edge of the right retaining wall, wherein the distance “L” is greater than the distance “1”.

8. The locking mechanism of claim 1, wherein the at least one detachable frame comprises a first detachable frame and a second detachable frame connected with the first detachable frame through an engagement between the edge connector and the locking retainer.

9. The locking mechanism of claim 1, wherein the locking retainer further comprises a middle retaining wall extended between the left retaining wall and the right retaining wall, wherein the middle retaining wall, the left retaining wall, and the right retaining wall are formed a U-shaped receiving cavity.

10. The locking mechanism of claim 1, wherein the left protrusion and the right protrusion are passed through the retaining through-holes.

11. The locking mechanism of claim 1, wherein the left protrusion comprises a left groove formed on a left distal end of the left protrusion, and the right protrusion comprises a right groove formed on a right distal end of the right protrusion.

12. The locking mechanism of claim 1, further comprising a left retaining slot formed between the left retaining wall and a main supporting base of the locking retainer and a right retaining slot formed between the right retaining wall and the main supporting base of the locking retainer.

13. The locking mechanism of claim 12, wherein the left protrusion further comprises a left tooth slidably engaged with the left retaining slot.

14. The locking mechanism of claim 12, wherein the right protrusion further comprises a right tooth slidably engaged with the right retaining slot.

15. The locking mechanism of claim 12, wherein the left protrusion comprises a left groove formed at a first distance from a left distal end of the left protrusion, wherein the first distance is smaller than a width of the left retaining slot.

16. The locking mechanism of claim 12, wherein the left retaining slot has a width defining between the left retaining wall of the locking retainer and a main supporting base of the locking retainer.

17. The locking mechanism of claim 1, wherein the right protrusion comprises a right groove formed at a second distance from a right distal end of the right protrusion, wherein the second distance is smaller than a width of the right retaining slot.

18. The locking mechanism of claim 12, wherein the right retaining slot has a width defining between the right retaining wall of the locking retainer and a main supporting base of the locking retainer.
